(19) United States
(12) Patent Application Publication
(10) Pub. No.: US 2016/0080023 A1
(43) Pub. Date: Mar. 17, 2016

(54) ELECTRONIC DEVICE WITH COVER

(71) Applicant: HON HAI PRECISION INDUSTRY CO., LTD., New Taipei (TW)

(72) Inventor: KUO-HSIANG OU YANG, New Taipei (TW)

(21) Appl. No.: 14/489,210

(22) Filed: Sep. 17, 2014

(51) Int. Cl. H04B 1/3888; H04M 1/11

(52) U.S. Cl. CPC H04B 1/3888; H04M 1/11

(57) ABSTRACT

A cover can include a cover body configured to cover the electronic device and two attaching walls located at two opposite sides of the cover body respectively. Each of the attaching walls can include an operating beam and two coupling blocks extending from two opposite ends of the operating beam. The two coupling blocks are pivotally coupled to the cover body. The two coupling blocks each have at least a portion thereof being a magnet or a metal block which can attract the magnet. The two coupling blocks are configured to couple the electronic device via magnetic force between the coupling blocks and the electronic device.

### FIELD

The present disclosure relates to electronic devices, and more particularly to an electronic device with a cover.

### BACKGROUND

Nowadays, some electronic devices, such as tablet computers, pads, mobile phones generally need covers configured to protect screens thereof.

### BRIEF DESCRIPTION OF THE DRAWINGS

FIG. 1 is an exploded, isometric view of an electronic device with a cover in accordance with an embodiment of the present disclosure.

FIG. 2 is an enlarged view of circled portion II of FIG. 1.

FIG. 3 is an assembled, isometric view of the electronic device with the cover in FIG. 1.

FIG. 4 is another isometric view of the electronic device with the cover in FIG. 3, wherein the cover is opened from a first lateral side of the electronic device.

FIG. 5 is an additional isometric view of the electronic device with the cover in FIG. 3, wherein the cover is opened from a second lateral side of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a cover configured to cover an electronic device. The cover can include a cover body configured to cover the electronic device and two attaching walls located at two opposite sides of the cover body respectively. Each of the attaching walls can include an operating beam and two coupling blocks extending from two opposite ends of the operating beam. The two coupling blocks are pivotally coupled to the cover body. The two coupling blocks each have at least a portion thereof being a magnet or a metal block which can attract the magnet. The two coupling blocks are configured to couple the electronic device via magnetic force between the coupling blocks and the electronic device.

The present disclosure is described further in relation to an electronic system. The electronic system can include an electronic device including a main body and a plurality of coupling members located in the main body. The cover is configured to couple the electronic device and cover the electronic device. The cover can include a cover body and two attaching walls pivotally coupled to two opposite sides of the cover body respectively. The two attaching walls are configured to be coupled to two opposite lateral sides of the electronic device via magnetic force between the attaching walls and the coupling members of the electronic device. Wherein the cover is transitionable between: (i) a first configuration in which the cover body covers a face of the electronic device, the two attaching walls are coupled to the two opposite lateral sides of the electronic device via magnetic force between the attaching walls and the coupling members of the electronic device, and (ii) a second configuration in which at least one of the two attaching walls is detached from at least one of the two opposite lateral sides of the electronic device, and the cover body is detached from the face of the electronic device.

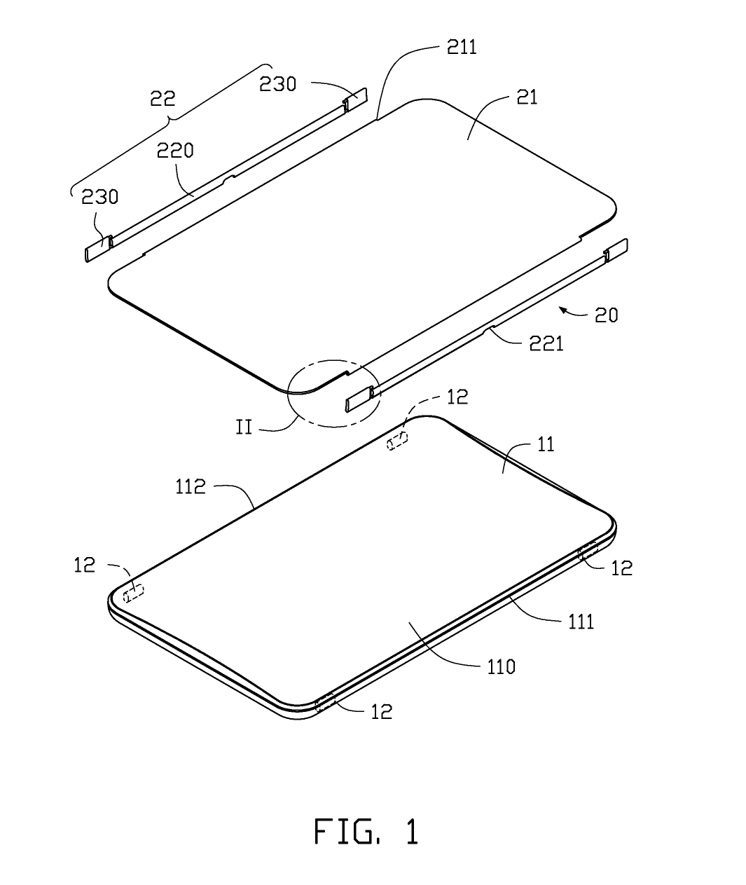

FIGS. 1-3 illustrate an electronic system including an electronic device 10 and a cover 20 configured to couple the electronic device 10. The electronic device 10 can be a tablet computer, a pad, or a mobile phone. The cover 20 can be a protecting cover made from plastic, cloth, leather or other material.

Referring to FIG. 1, the electronic device 10 can include a main body 11 and a plurality of coupling members 12 located in the main body 11. The main body 11 includes a screen at a top face 110 thereof. The coupling members 12 each can be a magnet or a metal block which can attract the magnet. The metal block can be an iron block, a nickel block or a cobalt block. In the embodiment, there are four coupling members 12 embedded in four spaced positions adjacent to four corners of the main body 11. Two coupling members 12 are located adjacent to a first lateral side 111 of the main body 11. The other two coupling members 12 are located adjacent to a second lateral side 112 of the main body 11. The first lateral side 111 is opposite to the second lateral side 112.

The cover 20 can include a cover body 21 and two attaching walls 22 coupled to two opposite sides of the cover body 21.

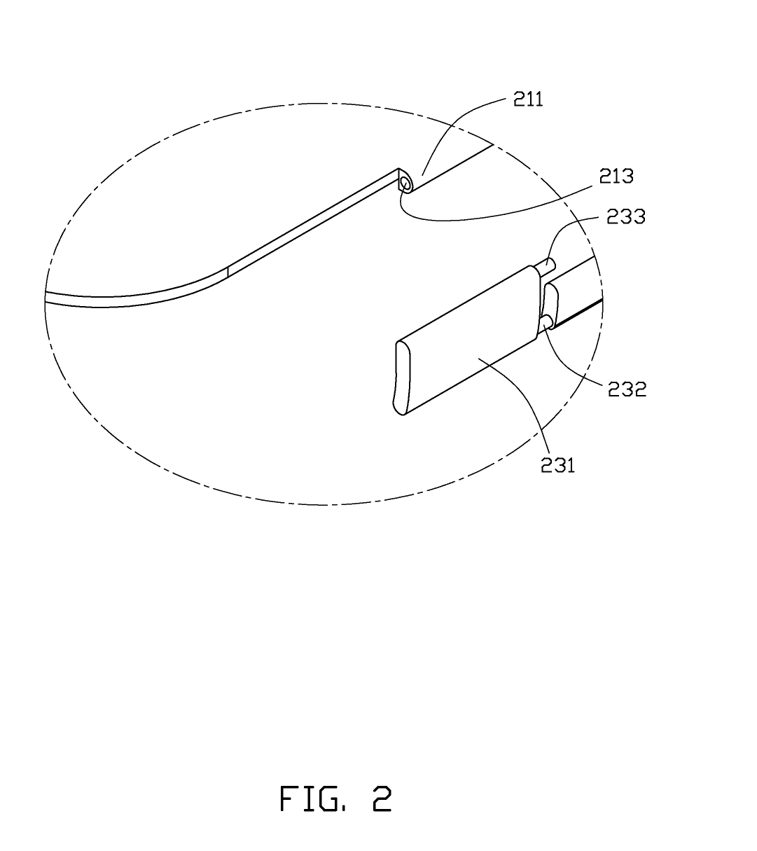

Referring also to FIG. 2, the cover body 21 can have a size substantially as same as that of the top face of the main body 11 of the electronic device 10, configured to cover the top face 110 of the main body 11. The cover body 21 has a first side and a second side opposite to and substantially parallel to the first side. The first side and the second side extend two engaging arms 211 respectively. Each engaging arm 211 forms two first pivot structures 213 at two opposite ends thereof. The first pivot structure 213 can be a pivot hole or a pivot pole.

Each attaching wall 22 can include an operating beam 220 and two coupling blocks 230 extending from two opposite ends of the operating beam 220. The operating beam 220 can have a length substantially equal to that of the engaging arm 211. The operating beam 220 defines a finger hole 221 at a lateral side of a middle portion of the operating beam 220. Each coupling block 230 can include an engaging portion 231, a coupling portion 232 extending from an end of the engaging portion 231 facing the operating beam 220, and a second pivot structure 233 formed at the end of the engaging portion 231. Each coupling block 230 at least has the engaging portion 231 being a magnet or a metal block which can attract the magnet. The metal block can be an iron block, a nickel block or a cobalt block. The coupling portion 232 is coupled to or integrally extending from the operating beam 220. The coupling portion 232 is located between the operating beam 220 and the engaging portion 231. The second pivot structure 233 can be a pivot pole or a pivot hole. In assembly of the cover 20, the second pivot structures 233 of the coupling blocks 230 of each attaching wall 22 pivotally engage the first pivot structures 213 of a corresponding engaging arm 211 of the cover body 21, therefore, the attaching wall 22 is pivotally coupled to the cover body 21. The engaging arm 211 is located between the two coupling blocks 230 of a corresponding attaching wall 22. It can be understood that, when the first pivot structure 213 is the pivot hole, the second pivot structure 233 can be the pivot pole. When the first pivot structure 213 is the pivot pole, the second pivot structure 233 can be the pivot hole.

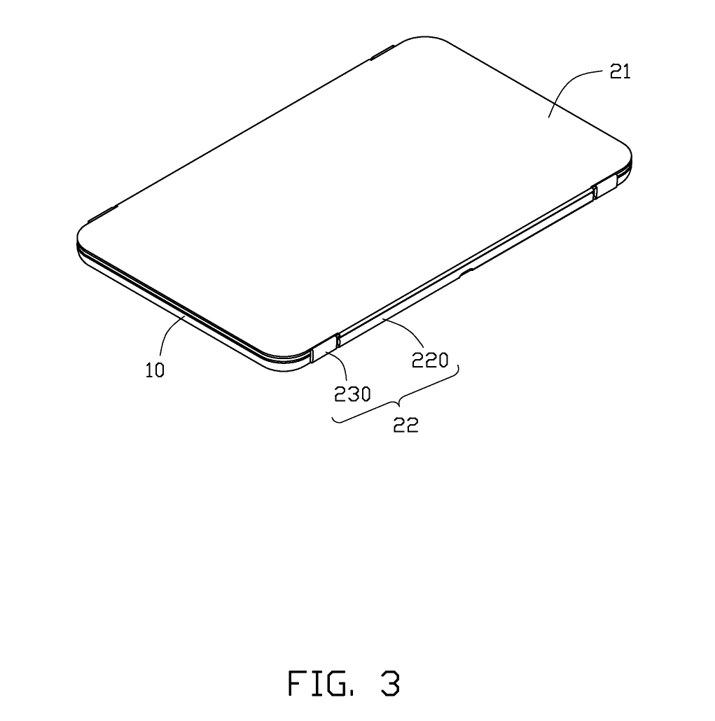

Referring also to FIG. 3, when the cover 20 is assembled to the electronic device 10, the cover 20 has the cover body 21 resting on the top face 110 of the electronic device 10. The attaching walls 22 are located at the first and second lateral sides 111, 112 of the electronic device 10. Each coupling block 230 is corresponding to the coupling member 12 of the electronic device 10. When the coupling member 12 is the magnet, the coupling block 230 can be the metal block which can attract the magnet. When the coupling member 12 is the metal block which can attract the magnet, the coupling block 230 can be the magnet. The coupling member 12 and the coupling block 230 both can be the magnets attracting each other. Therefore, the coupling block 230 has the engaging portion 231 magnetically coupled to the electronic device 10 via magnetic force between the engaging portion 231 and the coupling member 12, the cover 20 is assembled to the electronic device 10.

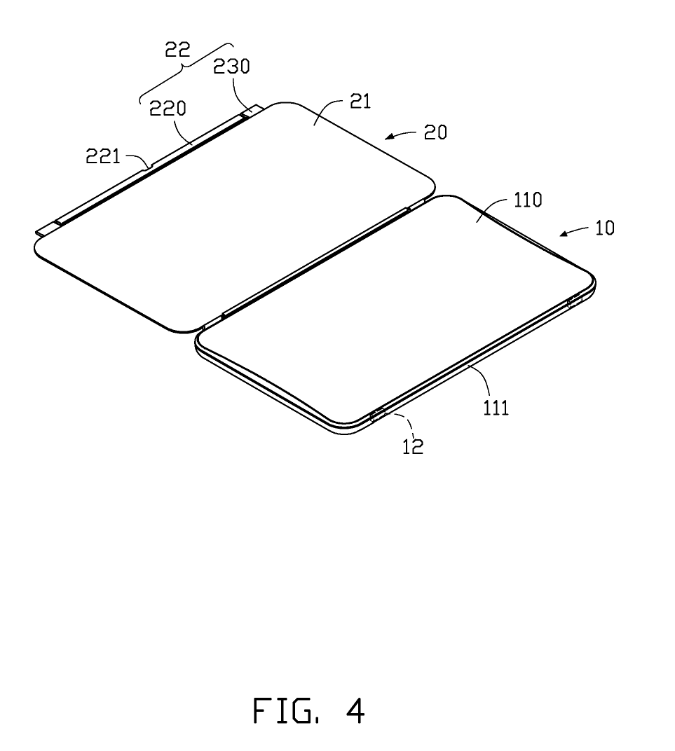

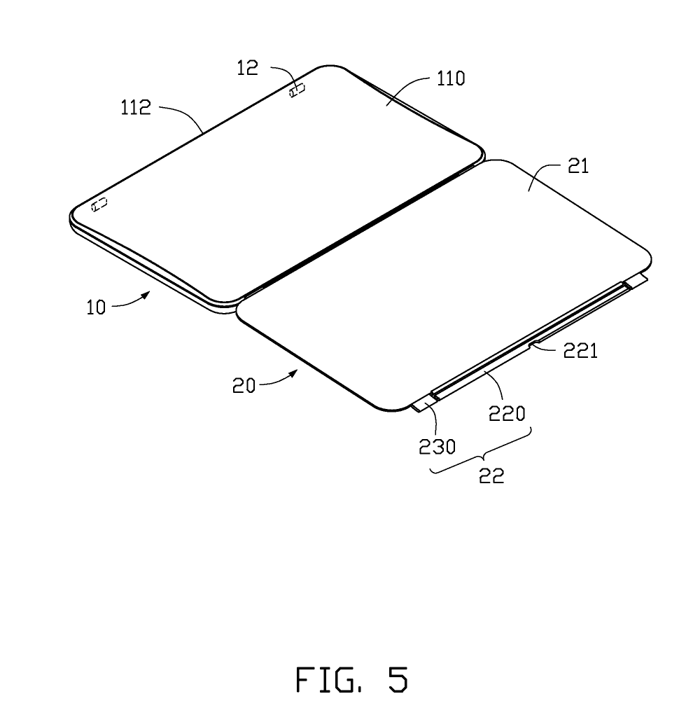

Referring also to FIG. 4 and FIG. 5, the cover 20 can be opened from the first lateral side 111 or the second lateral side 112 of the electronic device 10 via pulling any one of the operating beams 220 of the cover 20 by a finger put into the finger hole 221 of the operating beam 220. So, when a user wants to open the cover 20, he/she just needs to put a finger into the finger hole 221 of any one of the operating beams 220 to pulling the operating beam 220, according to personal habit of the user.

Therefore, in use, the cover 20 is transitionable between: (i) a first configuration in which the cover body 21 covers the top face 110 of the electronic device 10, the two attaching walls 22 are magnetically coupled to the two opposite lateral sides 111, 112 of the electronic device 10 via magnetic force between the attaching walls 22 and the coupling members 12 of the electronic device 10, and (ii) a second configuration in which at least one of the two attaching walls 22 is detached from at least one of the two opposite lateral sides 111, 112 of the electronic device 10 by pulling the operating beam 220, and the cover body 21 is detached from the top face 110 of the electronic device 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cover configured to cover an electronic device, the cover comprising:
a cover body configured to cover a face of the electronic device; and
two attaching walls located at two opposite sides of the cover body respectively, each of the attaching walls comprising an operating beam and two coupling blocks extending from two opposite ends of the operating beam, the two coupling blocks pivotally coupled to the cover body, the two coupling blocks having at least a portion thereof being a magnet or a metal block which can attract the magnet, the two coupling blocks configured to couple the electronic device via magnetic force between the coupling blocks and the electronic device.

2. The cover of claim 1, wherein each of the two coupling blocks comprises an engaging portion configured to couple the electronic device via magnetic force between the engaging portion and the electronic device, and a coupling portion extending from an end of the operating beam.

3. The cover of claim 2, wherein the cover body forms two first pivot structures at each of the two opposite sides, the two coupling blocks of each of the attaching walls forming two second pivot structures at the ends of the engaging portions respectively, the first pivot structure pivotally engaging the second pivot structure.

4. The cover of claim 3, wherein the cover body extends two engaging arms from the two opposite side thereof, respectively, the two first pivot structures formed at two opposite ends of each of the engaging arms.

5. The cover of claim 3, wherein the first pivot structure is a pivot hole, the second pivot structure being a pivot pole inserted into the pivot hole.

6. The cover of claim 4, wherein each of the engaging arms is located between the two coupling blocks of a corresponding attaching wall.

7. The cover of claim 1, wherein the operating beam defines a finger hole at a lateral side of the operating beam.

8. An electronic system comprising:
an electronic device comprising a main body and a plurality of coupling members located in the main body; and
a cover configured to couple the electronic device and cover the electronic device, the cover comprising a cover body and two attaching walls pivotally coupled to two opposite sides of the cover body respectively, the two attaching walls configured to be coupled to two opposite lateral sides of the electronic device via magnetic force between the attaching walls and the coupling members of the electronic device;
wherein the cover is transitionable between: (i) a first configuration in which the cover body covers a face of the electronic device, the two attaching walls are coupled to the two opposite lateral sides of the electronic device via magnetic force between the attaching walls and the coupling members of the electronic device, and (ii) a second configuration in which at least one of the two attaching walls is detached from at least one of the two opposite lateral sides of the electronic device, and the cover body is detached from the face of the electronic device.

9. The electronic system of claim 8, wherein each of the attaching walls comprises an operating beam and two coupling blocks extending from two opposite ends of the operating beam, the coupling blocks configured to couple the electronic device via magnetic force between the coupling blocks and the coupling members, the attaching wall is detached from the lateral side of the electronic device by pulling the operating beam.

10. The electronic system of claim 9, wherein each of the coupling blocks comprises an engaging portion configured to couple the electronic device via magnetic force between the engaging portion and the coupling member, and a coupling portion located between the operating beam and the engaging portion.

11. The electronic system of claim 10, wherein the cover body forms two first pivot structures at each of the two opposite sides, the two coupling blocks of each of the attaching walls forming two second pivot structures pivotally engaging the first pivot structures.

12. The electronic system of claim 11, wherein the cover body extends two engaging arms from the two opposite side thereof, the two first pivot structures formed at two opposite ends of each of the engaging arms.

13. The electronic system of claim 11, wherein the first pivot structure is a pivot hole, the second pivot structure being a pivot pole inserted into the pivot hole.

14. The electronic system of claim 12, wherein each of the engaging arms is located between the two coupling blocks of a corresponding attaching wall.

15. The electronic system of claim 9, wherein the operating beam defines a finger hole at a lateral side of the operating beam.

16. An electronic device protective cover comprising:
a cover body configured to substantially cover a face of a protected electronic device, the cover body having a first side and a second side, opposite to and substantially parallel to the first side;
a first attaching wall pivotally attached to the first cover body side;
a second attaching wall pivotally attached to the second cover body side;
wherein, at least one of the first attaching wall and the second attaching wall is magnetically attachable to the protected electronic device.

17. The electronic device protective cover of claim 16, wherein each the first attaching wall and the second attaching wall has an operating portion and one or more coupling blocks, and wherein, the one or more coupling blocks of the first attaching wall and the second attaching wall are magnetically attachable to the protected electronic device.
